(19) United States
(12) Patent Application Publication
(10) Pub. No.: US 2011/0212299 A1
(43) Pub. Date: Sep. 1, 2011

(54) FIBROUS STRUCTURE PRODUCT WITH HIGH WET BULK RECOVERY

(76) Inventors: Dinah Achola Nyangiro, Mason, OH (US); Ward William Ostendorf, West Chester, OH (US); Mark Casey Fox, Milford, OH (US); Fred Hamlin Murrell, JR., Greenhills, OH (US)

(21) Appl. No.: 13/034,789

(22) Filed: Feb. 25, 2011

Related U.S. Application Data
(60) Provisional application No. 61/308,649, filed on Feb. 26, 2010.

(51) Int. Cl. B32B 3/30; B32B 29/02; B31F 1/12

(52) U.S. Cl. 428/153; 428/535; 162/111; 162/100

(57) ABSTRACT

A fibrous structure product has one or more plies of fibrous structure having a Residual Wet Caliper from 26 mils to about 45 mils and a Wet Recovery Distance from 32 mils to about 45 mils.

### CROSS REFERENCE TO RELATED APPLICATION

This application claims the benefit of U.S. Provisional Application No. 61/308,649 filed Feb. 26, 2010.

### FIELD OF THE INVENTION

The present invention relates to fibrous structure products, more specifically single or multi-ply fibrous structure products having multiple enhanced attributes including high wet bulk recovery and methods of making the same.

### BACKGROUND OF THE INVENTION

Cellulosic fibrous structures are a staple of everyday life. Cellulosic fibrous structures are used as consumer products for paper towels, toilet tissue, facial tissue, napkins, and the like. The large demand for such paper products has created a demand for improved versions of the products and the methods of their manufacture.

Consumers prefer cellulosic fibrous structure products having multiple attributes. These attributes include softness, absorbency, strength, flexibility, and bulk. Consumers may especially prefer fibrous structure products having higher wet bulk and wet caliper, including those having relatively higher wet bulk recovery and higher wet caliper (thickness when wet). These attributes may communicate to the consumer that the product will be durable and strong and that the product will be useful for a variety of cleaning tasks. Moreover, these attributes communicate that the product will last and perform throughout the cleaning process and retain its physical integrity during use, and thus that the product has good value.

Providing a product with improved wet bulk recovery and therefore an improved impression of strength and durability without sacrificing other product attributes such as softness and absorbency, is difficult. Hence, the present invention unexpectedly provides a fibrous structure product with enhanced wet bulk recovery while also providing other consumer pleasing attributes such as absorbency, strength, and softeners. The present invention provides a fibrous structure that exhibits a particular range of wet bulk recovery and higher wet caliper as described herein, which unexpectedly provides a product with enhanced durability and/or ability to hold up throughout the cleaning process.

### SUMMARY OF THE INVENTION

The present invention, in an embodiment, relates to a single or multiply fibrous structure product comprising: one or more plies of fibrous structure having a Residual Wet Caliper from 26 mils to about 45 mils and a Wet Recovery Distance from 32 mils to about 45 mils wherein a single ply fibrous structure product may further comprise a Residual Wet Caliper/Initial Wet Caliper Ratio from about 0.55 to about 0.7 and the multiply fibrous structure product may further comprise a Residual Wet Caliper/Initial Wet Caliper Ratio from about 0.52 to about 0.8.

### BRIEF DESCRIPTION OF THE DRAWINGS

Without intending to limit the invention, embodiments are described in more detail below:

FIG. 1 is an example of a fragmentary plan view of a ply of a fibrous structure product of the present invention with a pattern imparted to the ply during the papermaking process.

FIG. 1A is a cross sectional view of a portion of the ply of fibrous structure product shown in FIG. 1 as taken along line 1A-1A.

FIG. 2 is an example of a fragmentary plan view of another ply of a fibrous structure product of the present invention with a pattern imparted to the ply during the papermaking process.

FIG. 2A is a cross sectional view of a portion of the ply of fibrous structure product shown in FIG. 2 as taken along line 2A-2A.

FIG. 3 is a cross sectional view of the ply of FIG. 1 and of FIG. 2 where the ply of FIG. 1 is adjacent to the ply of FIG. 2 to create a two ply fibrous structure product of the present invention.

### DETAILED DESCRIPTION OF THE INVENTION

### Definitions

As used herein, “paper product” refers to any formed, fibrous structure products, traditionally, but not necessarily, comprising cellulose fibers. In one embodiment, the paper products of the present invention include tissue-towel paper products.

A “tissue-towel paper product” refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the fibers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

The term “fibrous structure”, as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

“Sheet Caliper” or “Caliper”, as used herein, means the macroscopic thickness of a product sample under load.

“Patterned densified”, as used herein, means a portion of a fibrous structure product that is characterized by having a relatively high-bulk field of relatively low fiber density and an array of densified zones of relatively high fiber density. The high-bulk field is alternatively characterized as a field of pillow or dome regions. The densified zones are alternatively referred to as knuckle regions. The densified zones may be discretely spaced within the high-bulk field or may be interconnected (and e.g. continuous), either fully or partially, within the high-bulk field. One embodiment of a method of making a pattern densified fibrous structure and devices used therein are described in U.S. Pat. Nos. 4,529,480 and 4,528,239.

“Densified”, as used herein, means a portion of a fibrous structure product that exhibits a higher density than another portion of the fibrous structure product.

“Non-densified”, as used herein, means a portion of a fibrous structure product that exhibits a lesser density than another portion of the fibrous structure product.

“Bulk Density”, as used herein, means the apparent density of an entire fibrous structure product rather than a discrete area thereof.

“Laminating” refers to the process of firmly uniting superimposed layers of paper with or without adhesive, to form a multi-ply sheet.

“Non-naturally occurring” as used herein means that the fiber is not found in nature in that form. In other words, some chemical processing of materials needs to occur in order to obtain the non-naturally occurring fiber. For example, a wood pulp fiber is a naturally occurring fiber, however, if the wood pulp fiber is chemically processed, such as via a lyocell-type process, a solution of cellulose is formed. The solution of cellulose may then be spun into a fiber. Accordingly, this spun fiber would be considered to be a non-naturally occurring fiber since it is not directly obtainable from nature in its present form.

“Naturally occurring fiber” as used herein means that a fiber and/or a material is found in nature in its present form. An example of a naturally occurring fiber is a wood pulp fiber.

### Fibrous Structure Product

In one embodiment a multiply fibrous structure product comprises two or more plies of fibrous structure, a Residual Wet Caliper from 26 mils to about 45 mils; and a Wet Recovery Distance from 32 mils to about 45 mils. The multiply fibrous structure product may further comprise a Residual Wet Caliper/Initial Wet Caliper Ratio of from about 0.52 to about 0.8. In another embodiment the Residual Wet Caliper/Initial Wet Caliper Ratio is from about 0.53 to about 0.8 and in yet another embodiment is from about 0.54 to about 0.6.

In another embodiment the fibrous structure product comprises a single ply of fibrous structure wherein the fibrous structure has a Residual Wet Caliper from 26 mils to about 45 mils; and a Wet Recovery Distance from 32 mils to about 45 mils. In another embodiment the single ply fibrous structure product may further comprise a Residual Wet Caliper/Initial Wet Caliper Ratio is from about 0.55 to about 0.7 and in yet another embodiment is from about 0.58 to about 0.6.

In another embodiment the Wet Recovery Distance is from about 0.9 mm to about 1 mm.

In one embodiment, the fibrous structure product having two or more plies has a basis weight of about 30 lbs/3000 ft² to about 60 lbs/3000 ft², in another embodiment the basis weight is about 35 lbs/3000 ft² to about 45 lbs/3000 ft²; in another embodiment the basis weight is about 36 lbs/3000 ft² to about 43 lbs/3000 ft². In one embodiment, the a one ply fibrous structure product has a basis weight of about 15 lbs/3000 ft² to about 40 lbs/3000 ft², in another embodiment the basis weight is about 20 lbs/3000 ft² to about 30 lbs/3000 ft².

In one embodiment the fibrous structure product has an Initial Wet Caliper of from about 25 mils to about 70 mils; in another embodiment from about 50 mils to about 70 mils, and in another embodiment from about 55 mils to about 65 mils, as measured by the test method as disclosed herein.

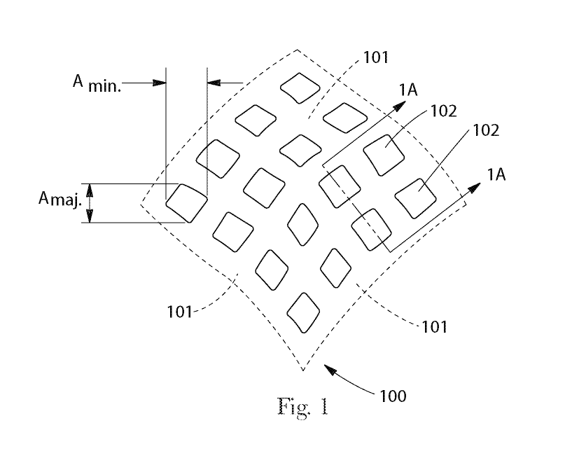

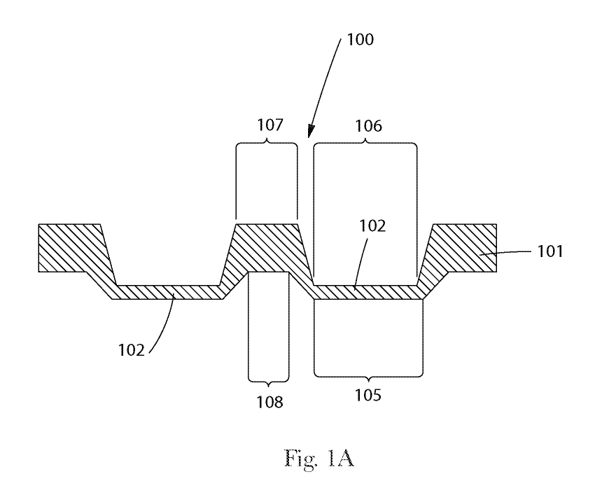

A nonlimiting example of a first ply 100 of a multi-ply fibrous structure product in accordance with the present invention is shown in FIG. 1. As shown in FIG. 1 a fragmentary plan view of a first ply 100 of multi-ply fibrous structure comprising two plies of fibrous structure wherein the first ply 100 has a continuous dome region 101 formed by a resin coated woven belt during the papermaking process and ordered in a regular arrangement. The exemplary first ply 100 further comprises a plurality of discrete knuckles 102 also formed by a resin coated woven belt during the papermaking process and ordered in a regular arrangement.

The first ply 100 has a cross section 1A-1A and is shown in FIG. 1A. As shown in FIG. 1A, the first ply 100 comprises a plurality of discrete knuckles 102 and a continuous dome region 101. The first ply 100 comprises an outer knuckle surface 105 comprising the total top projected surface of the knuckle. The first ply further comprises an inner knuckle surface 106, an outer dome surface 107 and an inner dome surface 108.

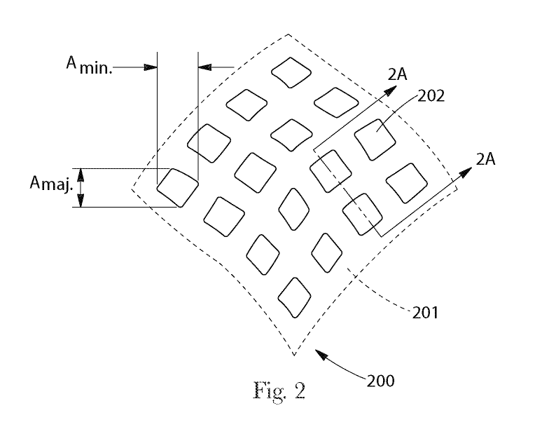

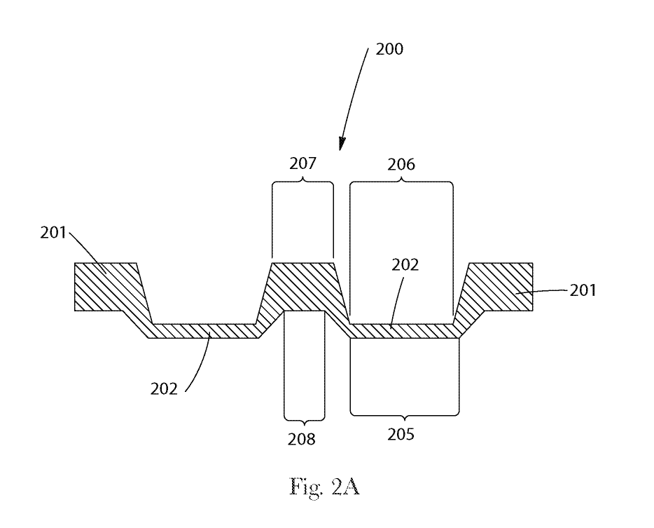

A nonlimiting example of a second ply 200 of a multi-ply fibrous structure product in accordance with the present invention is shown in FIG. 2. As shown in FIG. 2 a fragmentary plan view of a second ply 200 of multi-ply fibrous structure comprising two plies of fibrous structure wherein the second ply 200 has a continuous dome region 201 formed by a resin coated woven belt during the papermaking process and ordered in a regular arrangement. The exemplary second ply 200 further comprises a plurality of discrete knuckles 202 also formed by a resin coated woven belt during the papermaking process and ordered in a regular arrangement. The second ply 200 has a cross section 2A-2A and is shown in FIG. 2A. As shown in FIG. 2A, the second ply 200 comprises a plurality of discrete knuckles 202 and a continuous dome region 201. The second ply 200 comprises an outer knuckle surface 205 comprising the total top projected surface of the knuckle. The second ply 200 further comprises an inner knuckle surface 206, an outer dome surface 207 and an inner dome surface 208.

In one embodiment the first ply 100 comprises from about 20 knuckles/in² to about 110 knuckles/in², in another embodiment from about 30 knuckles/in² to about 100 knuckles/in², or from about 80 knuckles/in² to about 100 knuckles/in². In one embodiment the second ply 200 comprises from about 20 knuckles/in² to about 110 knuckles/in², in another embodiment from about 30 knuckles/in² to about 100 knuckles/in², or from about 80 knuckles/in² to about 100 knuckles/in². In one embodiment the multiply fibrous structure product comprises 2 plies wherein each of the plies comprises from about 80 knuckles/in² to about 100 knuckles/in²′ in another embodiment from about 90 knuckles/in² to about 100 knuckles/in². In one embodiment the knuckles are densified regions in the fibrous structure and the dome region is less densified than the knuckle region.

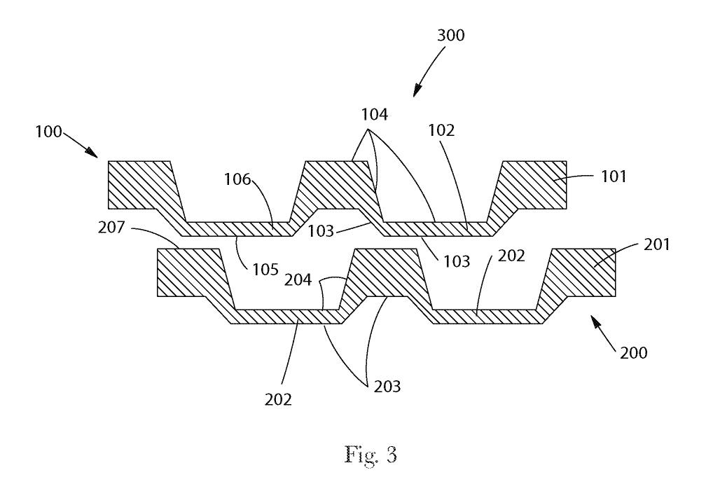

As shown in FIG. 3 the first ply 100 and the second ply 200 are combined to form a fibrous structure product 300. As shown in FIG. 3 the first ply 100 comprises a plurality of discrete knuckles 102 and a continuous dome region 101. The second ply 200 comprises a plurality of discrete knuckles 202 and a continuous dome region 201. As shown in FIG. 3 the fibrous structure product 300 comprises a first ply 100 comprising a first side 103 and a second side 104 and a second ply comprising a first side 203 and a second side 204, wherein the first side 103 of the first ply 100 faces and is adjacent to the second side 204 of the second ply 200.

In one embodiment and as shown in FIG. 3, the outer knuckle surface 105 of the first ply 100 is adjacent to at least part of the outer dome surface 207 of the second ply 200. Thus nesting of the first ply 100 and the second ply 200 is minimized. For example, as shown in FIG. 3 the continuous dome region 101 of the first ply is not completely aligned with the continuous dome region 201 of the second ply 200. The discrete knuckles 102 of the first ply 100 are not completely aligned with the discrete knuckles 202 of the second ply 200.

Table 1 shows examples of the Initial Wet Calipers, Wet Cyclic Compression Residual Caliper (or Residual Wet Caliper), Residual Wet Caliper/Initial Wet Caliper Ratio and the Wet Recovery Distance for various paper towel products as well as a paper towel products of the present invention. It was unexpected that the fibrous structure product of the present invention has a improved Residual Wet Caliper/Initial Wet Caliper Ratio, Wet Recovery Distance, and/or Residual Wet Caliper versus other paper towel fibrous structure products. Thus the fibrous structure product of the present invention provides better wet bulk recovery.

TABLE 1

| | | Wet | | |
|---|---|---|---|---|
| | | Cyclic | | |
| | | Compression | | |
| | | Residual | | |
| | Initial | Caliper | Residual Wet | Wet |
| | Wet | (or Residual | Caliper/Initial | Recovery |
| | Caliper | Wet Caliper) | Wet Caliper | Distance |
| Product | (mils) | (mils) | Ratio | (mils) |
| Paper Towel of | 55.9 | 27.8 | 0.50 | 37.5 |
| Present Invention | | | | |
| (2 ply) | | | | |
| Paper Towel of | 53.80 | 24.6 | 0.46 | 33.5 |
| Present Invention | | | | |
| (2 ply) | | | | |
| Thrifty Maid Paper | 33.0 | 10.9 | 0.33 | 17.2 |
| Towel (2 ply) | | | | |
| Sparkle Paper | 31.2 | 12.2 | 0.39 | 13.8 |
| Towel (2 ply) | | | | |
| Store Brand Paper | 35.2 | 17.6 | 0.50 | 18.5 |
| Towel (2 ply) | | | | |
| Bounty Paper | 50.8 | 20.3 | 0.40 | 28.8 |
| Towel (2 ply) | | | | |
| Brawny Paper | 45.3 | 20.3 | 0.45 | 26.7 |
| Towel (2 ply) | | | | |
| Prior Art Paper | 51.2 | 25.8 | 0.50 | 31.8 |
| Towel (2 ply) | | | | |
| Paper Towel of | 59.1 | 33.2 | 0.56 | 37.3 |
| Present Invention | | | | |
| (2 ply) | | | | |
| Scott Paper Towel | 39.6 | 20.8 | 0.53 | 31.9 |
| (1 ply) | | | | |
| Scott Extreme | 35.9 | 19.6 | 0.55 | 23.1 |
| Paper Towel (1 | | | | |
| ply) | | | | |

Without being limited by theory, the present invention provides a fibrous structure that exhibits a particular range of wet bulk recovery and initial wet caliper as described herein, which unexpectedly may provide a product with enhanced durability, strength impression, and/or ability to hold up throughout the cleaning process. In addition in an embodiment the orientation of the plies provides different cleaning impression wherein one side may present a coarser surface to better scrub and remove spills and other messes and the less coarse surface to finish the cleaning or to provide a surface for a “finer” mess removal or cleaning.

The present invention is equally applicable to all types of consumer paper products such as paper towels, toilet tissue, facial tissue, napkins, and the like.

The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps, as well as mechanical pulps including, groundwood, thermomechanical pulp, chemically modified, and the like. Chemical pulps may be used in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, other natural fibers such as cotton linters, bagesse, and the like, can be used. Additionally, fibers derived from recycled paper, which may contain any of all of the categories as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, polyethylene, and polypropylene fibers can be used within the scope of the present invention. Further, such fibers may be latex bonded.

In one embodiment the paper is produced by forming a predominantly aqueous slurry comprising about 95% to about 99.9% water. In one embodiment the non-aqueous component of the slurry used to make the fibrous structure comprises from about 5% to about 80% of eucalyptus fibers by weight of the non-aqueous components of the slurry. In another embodiment the non-aqueous components comprises from about 8% to about 60% of eucalyptus fibers by weight of the non aqueous components of the slurry, and in yet another embodiment from about 15% to about 30% of eucalyptus fibers by weight of the non-aqueous component of the slurry. In one embodiment the slurry comprises of about 45% to about 60% of Northern Softwood Kraft fibers, about 25% to about 35% unrefined Eucalyptus fibers and from about 5% to about 30% of either repulped product broke or thermo-mechanical pulp. The aqueous slurry can be pumped to the headbox of the papermaking process.

In one embodiment the present invention may comprise a co-formed fibrous structure. A co-formed fibrous structure comprises a mixture of at least two different materials wherein at least one of the materials comprises a non-naturally occurring fiber, such as a polypropylene fiber, and at least one other material, different from the first material, comprising a solid additive, such as another fiber and/or a particulate. In one example, a co-formed fibrous structure comprises solid additives, such as naturally occurring fibers, such as wood pulp fibers, and non-naturally occurring fibers, such as polypropylene fibers.

Synthetic fibers useful herein include any material, such as, but not limited to polymers, those selected from the group consisting of polyesters, polypropylenes, polyethylenes, polyethers, polyamides, polyhydroxyalkanoates, polysaccharides, and combinations thereof. More specifically, the material of the polymer segment may be selected from the group consisting of poly(ethylene terephthalate), poly(butylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or a mixture to make up the entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Nonlimiting examples of suitable bicomponent fibers are fibers made of copolymers of polyester (polyethylene terephthalate)/polyester (polyethylene terephthalate) otherwise known as “CoPET/PET” fibers, which are commercially available from Fiber Innovation Technology, Inc., Johnson City, Tenn.

These bicomponent fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papermaking process to make them more hydrophilic, more wettable, etc.

These multicomponent and/or synthetic fibers are further described in U.S. Pat. Nos. 6,746,766, issued on Jun. 8, 2004; 6,946,506, issued Sep. 20, 2005; 6,890,872, issued May 10, 2005; US Publication No. 2003/0077444A1, published on Apr. 24, 2003; US Publication No. 2003/0168912A1, published on Nov. 14, 2002; US Publication No. 2003/0092343A1, published on May 15, 2003; US Publication No. 2002/0168518A1, published on Nov. 14, 2002; US Publication No. 2005/0079785A1, published on Apr. 14, 2005; US Publication No. 2005/0026529A1, published on Feb. 3, 2005; US Publication No. 2004/0154768A1, published on Aug. 12, 2004; US Publication No. 2004/0154767, published on Aug. 12, 2004; US Publication No. 2004/0154769A1, published on Aug. 12, 2004; US Publication No. 2004/0157524A1, published on Aug. 12, 2004; US Publication No. 2005/0201965A1, published on Sep. 15, 2005.

The fibrous structure may comprise any tissue-towel paper product known in the industry. Embodiment of these substrates may be made according U.S. Pat. Nos. 4,191,609 issued Mar. 4, 1980 to Trokhan; 4,300,981 issued to Carstens on Nov. 17, 1981; 4,191,609 issued to Trokhan on Mar. 4, 1980; 4,514,345 issued to Johnson et al. on Apr. 30, 1985; 4,528,239 issued to Trokhan on Jul. 9, 1985; 4,529,480 issued to Trokhan on Jul. 16, 1985; 4,637,859 issued to Trokhan on Jan. 20, 1987; 5,245,025 issued to Trokhan et al. on Sep. 14, 1993; 5,275,700 issued to Trokhan on Jan. 4, 1994; 5,328,565 issued to Rasch et al. on Jul. 12, 1994; 5,334,289 issued to Trokhan et al. on Aug. 2, 1994; 5,364,504 issued to Smurkowski et al. on Nov. 15, 1995; 5,527,428 issued to Trokhan et al. on Jun. 18, 1996; 5,556,509 issued to Trokhan et al. on Sep. 17, 1996; 5,628,876 issued to Ayers et al. on May 13, 1997; 5,629,052 issued to Trokhan et al. on May 13, 1997; 5,637,194 issued to Ampulski et al. on Jun. 10, 1997; 5,411,636 issued to Hermans et al. on May 2, 1995; EP 677612 published in the name of Wendt et al. on Oct. 18, 1995, and U.S. Patent Application 2004/0192136A1 published in the name of Gusky et al. on Sep. 30, 2004.

The tissue-towel substrates may be manufactured via a wet-laid making process where the resulting web is through-air-dried or conventionally dried. Optionally, the substrate may be foreshortened by creping or by wet microcontraction. Creping and/or wet microcontraction are disclosed in commonly assigned U.S. Pat. Nos. 6,048,938 issued to Neal et al. on Apr. 11, 2000; 5,942,085 issued to Neal et al. on Aug. 24, 1999; 5,865,950 issued to Vinson et al. on Feb. 2, 1999; 4,440,597 issued to Wells et al. on Apr. 3, 1984; 4,191,756 issued to Sawdai on May 4, 1980; and 6,187,138 issued to Neal et al. on Feb. 13, 2001.

Conventionally pressed tissue paper and methods for making such paper are known in the art, for example U.S. Pat. No. 6,547,928 issued to Bamholtz et al. on Apr. 15, 2003. One suitable tissue paper is pattern densified tissue paper which is characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. Processes for making pattern densified tissue webs are disclosed in U.S. Pat. No. 3,301,746, issued to Sanford, et al. on Jan. 31, 1967; U.S. Pat. No. 3,974,025, issued to Ayers on Aug. 10, 1976; U.S. Pat. No. 4,191,609, issued on Mar. 4, 1980; and U.S. Pat. No. 4,637,859, issued on Jan. 20, 1987; U.S. Pat. No. 3,821,068, issued to Salvucci, Jr. et al. on May 21, 1974; U.S. Pat. No. 3,573,164, issued to Friedberg, et al. on Mar. 30, 1971; U.S. Pat. No. 3,473,576, issued to Amneus on Oct. 21, 1969; U.S. Pat. No. 4,239,065, issued to Trokhan on Dec. 16, 1980; and U.S. Pat. No. 4,528,239, issued to Trokhan on Jul. 9, 1985.

Uncompacted, non pattern-densified tissue paper structures are also contemplated within the scope of the present invention and are described in U.S. Pat. No. 3,812,000 issued to Joseph L. Salvucci, Jr. et al. on May 21, 1974; and U.S. Pat. No. 4,208,459, issued to Henry E. Becker, et al. on Jun. 17, 1980. Uncreped tissue paper as defined in the art are also contemplated. The techniques to produce uncreped tissue in this manner are taught in the prior art. For example, Wendt, et al. in European Patent Application 0 677 612A2, published Oct. 18, 1995; Hyland, et al. in European Patent Application 0 617 164 A1, published Sep. 28, 1994; and Farrington, et al. in U.S. Pat. No. 5,656,132 issued Aug. 12, 1997.

Uncreped tissue paper, in one embodiment, refers to tissue paper which is non-compressively dried, by through air drying. Resultant through air dried webs are pattern densified such that zones of relatively high density are dispersed within a high bulk field, including pattern densified tissue wherein zones of relatively high density are continuous and the high bulk field is discrete. The techniques to produce uncreped tissue in this manner are taught in the prior art. For example, Wendt, et. al. in European Patent Application 0 677 612A2, published Oct. 18, 1995; Hyland, et. al. in European Patent Application 0 617 164 A1, published Sep. 28, 1994; and Farrington, et. al. in U.S. Pat. No. 5,656,132 published Aug. 12, 1997.

Other materials are also intended to be within the scope of the present invention as long as they do not interfere or counteract any advantage presented by the instant invention.

The substrate which comprises the fibrous structure of the present invention may be cellulosic, non-cellulosic, or a combination of both. The substrate may be conventionally dried using one or more press felts or through-air dried. If the substrate which comprises the paper according to the present invention is conventionally dried, it may be conventionally dried using a felt which applies a pattern to the paper as taught by commonly assigned U.S. Pat. No. 5,556,509 issued Sep. 17, 1996 to Trokhan et al. and PCT Application WO 96/00812 published Jan. 11, 1996 in the name of Trokhan et al. The substrate which comprises the paper according to the present invention may also be through air dried. A suitable through air dried substrate may be made according to commonly assigned U.S. Pat. No. 4,191,609.

In one embodiment, the fibrous structure is through air dried on a belt having a patterned framework. The belt according to the present invention may be made according to any of commonly assigned U.S. Pat. No. 4,637,859 issued Jan. 20, 1987 to Trokhan; U.S. Pat. No. 4,514,345 issued Apr. 30, 1985 to Johnson et al.; U.S. Pat. No. 5,328,565 issued Jul. 12, 1994 to Rasch et al.; and U.S. Pat. No. 5,334,289 issued Aug. 2, 1994 to Trokhan et al. The belts that result from the belt making techniques disclosed in the referenced patents provide advantages over conventional belts in the art and are herein referred to as resin coated woven belts.

In one embodiment, the patterned framework of the belt imprints a pattern comprising an essentially continuous network onto the paper and further has deflection conduits dispersed within the pattern. The deflection conduits extend between opposed first and second surfaces of the framework. The deflection conduits allow domes to form in the paper. In another embodiment, the patterned framework of the belt imprints a pattern comprising an essentially continuous network of deflection conduits dispersed within the pattern and a plurality of protuberances forming discrete knuckles into the fibrous structure.

The domes extend generally perpendicular to the paper and increase its caliper. The domes generally correspond in geometry, and during papermaking in position, to the deflection conduits of the belt described above. There are an infinite variety of possible geometries, shapes, and arrangements for the deflection conduits and the domes formed in the paper therefrom. These shapes include those disclosed in commonly assigned U.S. Pat. No. 5,275,700 issued on Jan. 4, 1994 to Trokan. Examples of these shapes include, but are not limited to those described as a bow-tie pattern or snowflake pattern. Further examples of these shapes include, but are not limited to, circles, ovals, diamonds, triangles, hexagons, and various quadrilaterals.

The domes protrude outwardly from the plane of the paper due to molding into the deflection conduits during the papermaking process. By molding into the deflection conduits during the papermaking process, the regions of the paper comprising the domes are deflected in the Z-direction.

If the fibrous structure has domes, or other prominent features in the topography, the domes, or other prominent feature, may be arranged in a variety of different configurations. These configurations include, but are not limited to: regular arrangements, random arrangements, multiple regular arrangements, and combinations thereof.

The fibrous structure product according to the present invention having domes may be made according to commonly assigned U.S. Pat. No. 4,528,239 issued Jul. 9, 1985 to Trokhan; U.S. Pat. No. 4,529,480 issued Jul. 16, 1985 to Trokhan; U.S. Pat. No. 5,275,700 issued Jan. 4, 1994 to Trokhan; U.S. Pat. No. 5,364,504 issued Nov. 15, 1985 to Smurkoski et al.; U.S. Pat. No. 5,527,428 issued Jun. 18, 1996 to Trokhan et al.; U.S. Pat. No. 5,609,725 issued Mar. 11, 1997 to Van Phan; U.S. Pat. No. 5,679,222 issued Oct. 21, 1997 to Rasch et al.; U.S. Pat. No. 5,709,775 issued Jan. 20, 1995 to Trokhan et al.; U.S. Pat. No. 5,795,440 issued Aug. 18, 1998 to Ampulski et al.; U.S. Pat. No. 5,900,122 issued May 4, 1999 to Huston; U.S. Pat. No. 5,906,710 issued May 25, 1999 to Trokhan; U.S. Pat. No. 5,935,381 issued Aug. 10, 1999 to Trokhan et al.; and U.S. Pat. No. 5,938,893 issued Aug. 17, 1999 to Trokhan et al.

In one embodiment the fibrous structure is made using the papermaking belt as disclosed in U.S. Pat. No. 5,334,289, issued on Aug. 2, 1994, Paul Trokhan and Glenn Boutilier.

In one embodiment the plies of the multi-ply fibrous structure may be the same substrate respectively or the plies may comprise different substrates combined to create desired consumer benefits. In one embodiment the fibrous structures comprise two plies of tissue substrate. In another embodiment the fibrous structure comprises a first ply, a second ply, and at least one inner ply.

In one embodiment of the present invention, the fibrous structure product has a plurality of embossments. In one embodiment the embossment pattern is applied only to the first ply, and therefore, each of the two plies serve different objectives and are visually distinguishable. For instance, the embossment pattern on the first ply provides, among other things, improved aesthetics regarding thickness and quilted appearance, while the second ply, being unembossed, is devised to enhance functional qualities such as absorbency, thickness and strength. In another embodiment the fibrous structure product is a two ply product wherein both plies comprise a plurality of embossments.

Suitable means of embossing include those disclosed in U.S. Pat. Nos. 3,323,983 issued to Palmer on Sep. 8, 1964; 5,468,323 issued to McNeil on Nov. 21, 1995; 5,693,406 issued to Wegele et al. on Dec. 2, 1997; 5,972,466 issued to Trokhan on Oct. 26, 1999; 6,030,690 issued to McNeil et al. on Feb. 29, 2000; and 6,086,715 issued to McNeil on July 11.

Suitable means of laminating the plies include but are not limited to those methods disclosed in commonly assigned U.S. Pat. Nos. 6,113,723 issued to McNeil et al. on Sep. 5, 2000; 6,086,715 issued to McNeil on Jul. 11, 2000; 5,972,466 issued to Trokhan on Oct. 26, 1999; 5,858,554 issued to Neal et al. on Jan. 12, 1999; 5,693,406 issued to Wegele et al. on Dec. 2, 1997; 5,468,323 issued to McNeil on Nov. 21, 1995; 5,294,475 issued to McNeil on Mar. 15, 1994.

The fibrous structure product may be in roll form. When in roll form, the fibrous structure product may be wound about a core or may be wound without a core.

### Optional Ingredients

The multi-ply fibrous structure product herein may optionally comprise one or more ingredients that may be added to the aqueous papermaking furnish or the embryonic web. These optional ingredients may be added to impart other desirable characteristics to the product or improve the papermaking process so long as they are compatible with the other components of the fibrous structure product and do not significantly and adversely effect the functional qualities of the present invention. The listing of optional chemical ingredients is intended to be merely exemplary in nature, and are not meant to limit the scope of the invention. Other materials may be included as well so long as they do not interfere or counteract the advantages of the present invention.

A cationic charge biasing species may be added to the papermaking process to control the zeta potential of the aqueous papermaking furnish as it is delivered to the papermaking process. These materials are used because most of the solids in nature have negative surface charges, including the surfaces of cellulosic fibers and fines and most inorganic fillers. In one embodiment the cationic charge biasing species is alum. In addition charge biasing may be accomplished by use of relatively low molecular weight cationic synthetic polymer, in one embodiment having a molecular weight of no more than about 500,000 and in another embodiment no more than about 200,000, or even about 100,000. The charge densities of such low molecular weight cationic synthetic polymers are relatively high. These charge densities range from about 4 to about 8 equivalents of cationic nitrogen per kilogram of polymer. An exemplary material is Cypro 514®, a product of Cytec, Inc. of Stamford, Conn.

High surface area, high anionic charge microparticles for the purposes of improving formation, drainage, strength, and retention may also be included herein. See, for example, U.S. Pat. No. 5,221,435, issued to Smith on Jun. 22, 1993.

If permanent wet strength is desired, cationic wet strength resins may be optionally added to the papermaking furnish or to the embryonic web. From about 2 to about 50 lbs./ton of dry paper fibers of the cationic wet strength resin may be used, in another embodiment from about 5 to about 30 lbs./ton, and in another embodiment from about 10 to about 25 lbs./ton.

The cationic wet strength resins useful in this invention include without limitation cationic water soluble resins. These resins impart wet strength to paper sheets and are well known to the paper making art. This resin may impart either temporary or permanent wet strength to the sheet. Such resins include the following Hercules products. KYMENE® resins obtainable from Hercules Inc., Wilmington, Del. may be used, including KYMENE® 736 which is a polyethyleneimine (PEI) wet strength polymer. It is believed that the PEI imparts wet strength by ionic bonding with the pulps carboxyl sites. KYMENE® 557LX is polyamide epichlorohydrin (PAE) wet strength polymer. It is believed that the PAE contains cationic sites that lead to resin retention by forming an ionic bond with the carboxyl sites on the pulp. The polymer contains 3-azetidinium groups which react to form covalent bonds with the pulps' carboxyl sites as well as with the polymer backbone. The product must undergo curing in the form of heat or undergo natural aging for the reaction of the azetidinium group. KYMENE® 450 is a base activated epoxide polyamide epichlorohydrin polymer. It is theorized that like 557LX the resin attaches itself ionically to the pulps' carboxyl sites. The epoxide group is much more reactive than the azetidinium group. The epoxide group reacts with both the hydroxyl and carboxyl sites on the pulp, thereby giving higher wet strengths. The epoxide group can also crosslink to the polymer backbone. KYMENE® 2064 is also a base activated epoxide polyamide epichlorohydrin polymer. It is theorized that KYMENE® 2064 imparts its wet strength by the same mechanism as KYMENE® 450. KYMENE® 2064 differs in that the polymer backbond contains more epoxide functional groups than does KYMENE® 450. Both KYMENE® 450 and KYMENE® 2064 require curing in the form of heat or natural aging to fully react all the epoxide groups, however, due to the reactiveness of the epoxide group, the majority of the groups (80-90%) react and impart wet strength off the paper machine. Mixtures of the foregoing may be used. Other suitable types of such resins include urea-formaldehyde resins, melamine formaldehyde resins, polyamide-epichlorohydrin resins, polyethyleneimine resins, polyacrylamide resins, dialdehyde starches, and mixtures thereof. Other suitable types of such resins are described in U.S. Pat. No. 3,700,623, issued Oct. 24, 1972; U.S. Pat. No. 3,772,076, issued Nov. 13, 1973; U.S. Pat. No. 4,557,801, issued Dec. 10, 1985 and U.S. Pat. No. 4,391,878, issued Jul. 5, 1983.

In one embodiment, the cationic wet strength resin may be added at any point in the processes, where it will come in contact with the paper fibers prior to forming the wet web.

If enhanced absorbency is needed, surfactants may be used to treat the paper webs of the present invention. The level of surfactant, if used, in one embodiment, from about 0.01% to about 2.0% by weight, based on the dry fiber weight of the tissue web. In one embodiment the surfactants have alkyl chains with eight or more carbon atoms. Exemplary anionic surfactants include linear alkyl sulfonates and alkylbenzene sulfonates. Exemplary nonionic surfactants include alkylglycosides including alkylglycoside esters such as Crodesta SL40® which is available from Croda, Inc. (New York, N.Y.); alkylglycoside ethers as described in U.S. Pat. No. 4,011,389, issued to Langdon, et al. on Mar. 8, 1977; and alkylpolyethoxylated esters such as Pegosperse 200 ML available from Glyco Chemicals, Inc. (Greenwich, Conn.) and IGEPAL RC-520® available from Rhone Poulenc Corporation (Cranbury, N.J.). Alternatively, cationic softener active ingredients with a high degree of unsaturated (mono and/or poly) and/or branched chain alkyl groups can greatly enhance absorbency.

In addition, chemical softening agents may be used. In one embodiment the chemical softening agents comprise quaternary ammonium compounds including, but not limited to, the well-known dialkyldimethylammonium salts (e.g., ditallowedimethylammonium chloride, ditallowedimethylammonium methyl sulfate (“DTDMAMS”), di(hydrogenated tallow)dimethyl ammonium chloride, etc.). In another embodiment variants of these softening agents include mono or diester variations of the before mentioned dialkyldimethylammonium salts and ester quaternaries made from the reaction of fatty acid and either methyl diethanol amine and/or triethanol amine, followed by quaternization with methyl chloride or dimethyl sulfate.

Another class of papermaking-added chemical softening agents comprises organo-reactive polydimethyl siloxane ingredients, including the amino functional polydimethyl siloxane. The fibrous structure product of the present invention may further comprise a diorganopolysiloxane-based polymer. These diorganopolysiloxane-based polymers useful in the present invention span a large range of viscosities; from about 10 to about 10,000,000 centistokes (cSt) at 25° C. Some diorganopolysiloxane-based polymers useful in this invention exhibit viscosities greater than 10,000,000 centistokes (cSt) at 25° C. and therefore are characterized by manufacturer specific penetration testing. Examples of this characterization are GE silicone materials SE 30 and SE 63 with penetration specifications of 500-1500 and 250-600 (tenths of a millimeter) respectively.

Among the diorganopolysiloxane polymers of the present invention are diorganopolysiloxane polymers comprising repeating units, where said units correspond to the formula (R₂SiO)ₙ, where R is a monovalent radical containing from 1 to 6 carbon atoms, in one embodiment selected from the group consisting of methyl, ethyl, propyl, isopropyl, butyl, isobutyl, t-butyl, amyl, hexyl, vinyl, allyl, cyclohexyl, amino alkyl, phenyl, fluoroalkyl and mixtures thereof. The diorganopolysiloxane polymers which may be employed in the present invention may contain one or more of these radicals as substituents on the siloxane polymer backbone. The diorganopolysiloxane polymers may be terminated by triorganosilyl groups of the formula (R′₃Si) where R′ is a monovalent radical selected from the group consisting of radicals containing from 1-6 carbon atoms, hydroxyl groups, alkoxyl groups, and mixtures thereof. In one embodiment the silicone polymer is a higher viscosity polymers, e.g., poly(dimethylsiloxane), herein referred to as PDMS or silicone gum, having a viscosity of at least 100,000 cSt.

Silicone gums, optionally useful herein, corresponds to the formula:

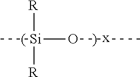

where R is a methyl group.

Fluid diorganopolysiloxane polymers that are commercially available, include SE 30 silicone gum and SF96 silicone fluid available from the General Electric Company. Similar materials can also be obtained from Dow Corning and from Wacker Silicones.

An additional fluid diorganosiloxane-based polymer optionally for use in the present invention is a dimethicone copolyol. The dimethicone copolyol can be further characterized as polyalkylene oxide modified polydimethysiloxanes, such as manufactured by the Witco Corporation under the trade name Silwet. Similar materials can be obtained from Dow Corning, Wacker Silicones and Goldschmidt Chemical Corporation as well as other silicone manufacturers. Silicones useful herein are further disclosed in U.S. Pat. Nos. 5,059,282; 5,164,046; 5,246,545; 5,246,546; 5,552,345; 6,238,682; 5,716,692.

In addition antibacterial agents, coloring agents such as print elements, perfumes, dyes, and mixtures thereof, may be included in the fibrous structure product of the present invention.

### EXAMPLES

### Example 1

One fibrous structure useful in the present invention is a through-air-dried (TAD), differential density structure. Such a structure may be formed by the following process. (Examples of TAD structures are generally described in U.S. Pat. No. 4,528,239.)

A Fourdrinier, through-air-dried papermaking machine is run under the following conditions to produce fibrous structure products of the present invention. A wet-micro-contracted fibrous structure product is produced herein, comprising the steps of: first forming an embryonic web from an aqueous fibrous papermaking furnish. A slurry of papermaking fibers is pumped to the headbox at a consistency of about 0.15%. The slurry consists of about 45% to about 50% of Northern Softwood Kraft fibers, about 25% to about 35% unrefined Eucalyptus fibers, about 20% to about 30% of either repulped product broke or thermo-mechanical pulp, and from about 10% to about 20% of Southern Softwood Kraft (SSK). A strength additive, Kymene 557H, is added to the furnish at a rate of about 20 pounds per ton (about 10 gms/kg). Kymene is a registered trademark of Hercules Inc, of Wilmington, Del. The web is then forwarded at a first velocity, V₁, on a carrier fabric to a transfer zone having a transfer/imprinting fabric. The water is partially removed from the wet web, by non-compressively removing water from the web to a fiber consistency of from about 10% to about 30%, immediately prior to reaching the is transfer zone to enable the web to be transferred to the transfer/imprinting fabric at the transfer zone. Dewatering occurs through the Fourdrinier wire and is assisted by vacuum boxes. The wire is of a configuration having 41.7 machine direction and 42.5 cross direction filaments per cm, available from Asten Johnson known as a “786 wire”.

The web is then transferred to the transfer/imprinting fabric in the transfer zone without precipitating substantial densification of the web. The web is then forwarded, at a second velocity, V₂, on the transfer/imprinting fabric along a looped path in contacting relation with a transfer head disposed at the transfer zone, the second velocity being from about 5% to about 40% slower than the first velocity. Since the wire speed is faster than the speed of the transfer/imprinting fabric, wet shortening of the web occurs at the transfer point. Thus, the wet web foreshortening may be about 15% to about 20%.

The transfer/imprinting fabric also called a second foraminous member or belt comprises a patterned framework of protuberances (or knuckles which may form discrete knuckles in the finished web) and a reinforcing structure. The patterned framework of knuckles comprises a photosensitive resin. The reinforcing structure is a fluid-permeable, woven fabric and has two opposed major surfaces. One major surface is the paper contacting side and from which the protuberances extend. The other major surface of the reinforcing structure of the papermaking belt is the backside, which contacts the machinery employed in a typical papermaking operation. Deflection conduits form in the belt between the protuberances. This belt has one surface (the embryonic web-contacting surface) comprising a macroscopically monoplanar network surface of protuberances (of photopolymer resin) which are in this example, discrete (but in other examples may be continuous, semicontinuous, and/or discontinuous, and patterned (e.g. the protuberances or knuckles of the belt may form densified regions of the fibrous structure). Also defined within the second foraminous member or belt is continuous deflection conduits, (in other examples the deflection conduits may be either discrete, discontinuous, continuous, or semicontinuous deflection conduits—e.g. in some instances the deflection conduits may form pillow regions or dome regions in the fibrous structure) formed between the protuberances of the belt.

The papermaking fibers in the embryonic web are deflected into the deflection conduits and water is removed from the embryonic web through the deflection conduits so as to form an intermediate web of papermaking fibers.

In an embodiment the patterned resin protuberances of the belt have a top surface area that corresponds to the area of inner knuckle surfaces of the fibrous structure. In an embodiment the patterned resin protuberances of the belt may correspond to densified regions of the fibrous structure made therefrom. The resin protuberances may cover about 20% to about 30% of the surface area of the reinforcing structure of the transfer/imprinting fabric. The polymer resin is supported by and attached to the reinforcing structure. The reinforcing structure, for example, may have 27.6 machine direction and 11.8 cross direction filaments per cm. The photopolymer resin protuberances may rise about 17 mils to about 27 mils above the top surface of the reinforcing structure.

In an embodiment the transfer/imprinting fabric forms a continuous, deflection conduit form by a patterned network of discrete photopolymer resin wherein the continuous deflection conduit forms a continuous dome region in the fibrous structure. The patterned network of discrete photopolymer resin may form discrete knuckles that may be discrete densified regions in the fibrous structure product.

The web is then adhesively secured to a drying cylinder having a third velocity, V₃. Polyvinyl alcohol creping adhesive is used. The drying cylinder is operated at a range of about 145° C. to about 170° C. or about 157° C., and the dryer, Yankee hoods, are operated at about 200° C. to about 250° C. The web is then dried on the drying cylinder without overall mechanical compaction of the web. The web is then creped from the drying cylinder with a doctor blade, the doctor blade having an impact angle of from about 90 degrees to about 130 degrees. Thereafter the dried web is reeled at a fourth velocity, V₄, that is faster than the third velocity, V₃, of the drying cylinder.

The paper described above is then subjected to a knob-to-rubber impression embossing process as follows. An emboss roll is engraved with a nonrandom pattern of protrusions. The emboss roll is mounted, along with a backside impression roll, in an apparatus with their respective axes being generally parallel to one another. The emboss roll comprises embossing protrusions which are frustaconical in shape. The backside impression roll is made of Valcoat™ material from Valley Roller Company, Mansfield, Tex. The paper web is passed through the nip to create an embossed ply.

The resulting paper may have a plurality of formed features corresponding to FIGS. 1, 1 A, 2, 2A and 3. The resulting paper has Residual Wet Caliper/Initial Wet Caliper is Ratio of about 0.56, a Wet Recovery Distance of about 37 mils, a Residual Wet Caliper of about 33 mils, and a basis weight of about 35 lbs./3,000 ft.² to about 43 lbs./3,000 ft.²

### Test Methods

The following describe the test methods utilized herein to determine the values consistent with those presented herein. All measurements for the test methods are made at 23+/−1° C. and 50%+/−2% relative humidity, unless otherwise specified.

### Initial Wet Caliper, Residual Wet Caliper, & Wet Recovery Distance Method

Caliper versus load data are obtained using a Thwing-Albert Model EJA Materials Tester, equipped with a 2000 g load cell and compression fixture. The compression fixture consisted of the following; load cell adaptor plate, 2000 gram overload protected load cell, load cell adaptor/foot mount 1.128 inch diameter presser foot, #89-14 anvil, 89-157 leveling plate, anvil mount, and a grip pin, all available from Thwing-Albert Instrument Company, Philadelphia, Pa. The compression foot is one square inch in area. The instrument is run under the control of Thwing-Albert Motion Analysis Presentation Software (MAP V1,1,6,9). A single sheet of a conditioned sample is cut to a diameter of approximately two inches. Samples are conditioned for a minimum of 2 hours at 23+/−1° C. and 50±2% relative humidity. Testing is carried out under the same temperature and humidity conditions. The sample must be less than 2.5-inch diameter (the diameter of the anvil) to prevent interference of the fixture with the sample. Care should be taken to avoid damage to the center portion of the sample, which will be under test. Scissors or other cutting tools may be used. For the test, the sample is centered on the compression table under the compression foot. Just before the test execution, the sample is saturated with 4.5 g water/g fiber. The compression-relaxation procedure is repeated 3 times on the same sample. The compression and relaxation data are obtained using a crosshead speed of 0.1 inches/minute. The deflection of the load cell is obtained by running the test without a sample being present. This is generally known as the Steel-to-Steel data. The Steel-to-Steel data are obtained at a crosshead speed of 0.005 inch/minute. Crosshead position and load cell data are recorded between the load cell range of 5 grams and 300 grams for both the compression and relaxation portions of the test. Since the foot area is one square inch this corresponded to a range of 5 grams/square inch in to 300 grams/square inch. The maximum pressure exerted on the sample is 300 g/square inch. At 300 g/square inch the crosshead reverses its travel direction. Crosshead position values are collected at selected load values during the test. These correspond to pressure values of 5, 10, 25, 50, 75, 100, 125, 150, 200, 300, 200, 150, 125, 100, 75, 50, 25, 10, 5 g/square inch. for the compression and the relaxation direction. During the compression portion of the test, crosshead position values are collected by the MAP software, by defining 10 traps (Trap1 to Trap 10) at load settings of C5, C10, C25, C50, C75, C100, C125, C150, C200, C300 During the return portion of the test, crosshead position values are collected by the MAP software, by defining ten return traps (Return Trap1 to Return Trap 10) at load settings of R300, R200, R150, R125, R100, R75, R50, R25, R10, R5. This cycle of compressions to 300 grams/square inch and return to 5 grams/square inch is repeated 3 times on the same sample without removing the sample. The 3 cycle compression-relaxation test is replicated 5 times for a given product using a fresh sample each time. The result is reported as an average of the 5 replicates. Again values are obtained for both the Steel-to-Steel and the sample. Steel-to-Steel values are obtained for each batch of testing. If multiple days are involved in the testing, the values are checked daily. The Steel-to-Steel values and the sample values are an average of four replicates (300 g).

Caliper values are obtained by subtracting the average Steel-to-Steel crosshead trap values from the sample crosshead trap value at each trap point. For example, the values from five individual replicates on each sample are averaged and used to obtain the Wet Cyclic Compression Residual Caliper, Wet Cyclic Compression Recovery Distance and the Wet Cyclic Compression Residual Caliper/Initial Wet Caliper ratio.

Wet Cyclic Compression Residual Caliper (or Residual Wet Caliper) is defined as the Caliper value at 5 g/square inch relaxation (R5) of the 3^{rd} compression cycle. Wet Compression Recovery Distance (or Wet Recovery Distance) is defined as the sum of differences between full compression caliper at 300 g/square inch (C300) of the 1^{st} cycle and initial compression caliper at 5 g/square inch (C5) of the 2^{nd} cycle plus differences between full compression caliper at 300 g/square inch (C300) of the 2^{nd} cycle and initial compression caliper at 5 g/square inch (C5) of the 3^{rd} cycle. Initial wet caliper to residual wet caliper is defined by C5 of the first cycles divide by R5 of the 3^{rd} compression cycle.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-ply fibrous structure product comprising:
2 or more plies of fibrous structure product;
a Residual Wet Caliper from 26 mils to about 45 mils; and
a Wet Recovery Distance from 32 mils to about 45 mils.

2. The fibrous structure product of claim 1 wherein the Residual Wet Caliper is about 27 mils to about 40 mils.

3. The fibrous structure product of claim 2 wherein the Residual Wet Caliper is about 28 mils to about 35 mils.

4. The fibrous structure product of claim 1 wherein the Wet Recovery Distance is about 33 mils to about 40 mils.

5. The fibrous structure product of claim 1 further comprising a Residual Wet Caliper/Initial Wet Caliper Ratio from about 0.52 to about 0.8.

6. The fibrous structure product of claim 5 wherein the Residual Wet Caliper/Initial Wet Caliper Ratio is about 0.54 to about 0.6.

7. The fibrous structure product of claim 1 comprising a basis weight of from 35 lbs./3,000 feet² to about 50 lbs./3,000 feet².

8. The fibrous structure product of claim 1 wherein the Initial Wet Caliper is from about 50 mils to about 70 mils.

9. The fibrous structure product of claim 1 wherein at least one of the plies of fibrous structure comprises creped or uncreped through-air-dried fibrous structure plies, differential density fibrous structure plies, wet laid fibrous structure plies, air laid fibrous structure plies, conventional fibrous structure plies and combinations thereof.

10. The fibrous structure product of claim 9 wherein the ply comprises a creped through-air dried tissue paper.

11. The fibrous structure product of claim 1 wherein the fibrous structure product has a first ply and a second ply where the first ply has an outer knuckle surface and the second ply has an outer dome surface wherein the outer knuckle surface is adjacent to at least part of the outer dome surface.

12. A fibrous structure product comprising:
a single ply of fibrous structure product;
a Residual Wet Caliper from 26 mils to about 45 mils; and
a Wet Recovery Distance from 32 mils to about 45 mils.

13. The fibrous structure product of claim 12 wherein the Residual Wet Caliper is about 27 mils to about 40 mils.

14. The fibrous structure product of claim 13 wherein the Residual Wet Caliper is about 28 mils to about 35 mils.

15. The fibrous structure product of claim 12 wherein the Wet Recovery Distance is about 0.9 mm to about 1 mm.

16. The fibrous structure product of claim 11 further comprising a Residual Wet Caliper/Initial Wet Caliper Ratio of about 0.55 to about 0.7.

17. The fibrous structure product of claim 16 wherein the Residual Wet Caliper/Initial Wet Caliper Ratio of about 0.58 to about 0.6.

18. The fibrous structure product of claim 12 comprising a basis weight of from 35 lbs./3,000 feet² to about 45 lbs./3,000 feet².

19. The fibrous structure product of claim 12 wherein the Initial Wet Caliper is from about 50 mils to about 70 mils.

20. The fibrous structure product of claim 12 wherein the ply comprises creped or uncreped through-air-dried fibrous structure plies, differential density fibrous structure plies, wet laid fibrous structure plies, air laid fibrous structure plies, conventional fibrous structure plies and combinations thereof.

21. The fibrous structure product of claim 20 wherein the ply comprises a creped through-air dried tissue paper.

22. A fibrous structure product comprising:
one or more plies of fibrous structure product comprising fibers consisting essentially of naturally occurring fibers;
a Residual Wet Caliper from 26 mils to about 45 mils; and
a Wet Recovery Distance from 32 mils to about 45 mils.
